(19) United States
(12) Patent Application Publication
(10) Pub. No.: US 2016/0193874 A1
(43) Pub. Date: Jul. 7, 2016

(54) PNEUMATIC TIRE

(71) Applicant: SUMITOMO RUBBER INDUSTRIES, LTD., Hyogo (JP)

(72) Inventors: Kazuo ASANO, Kobe-shi (JP); Yasuhiro KUBOTA, Kobe-shi (JP); Sawa OGIHARA, Kobe-shi (JP)

(73) Assignee: Sumitomo Rubber Industries, Ltd., Kobe-shi, Hyogo (JP)

(21) Appl. No.: 14/910,967

(22) PCT Filed: Jul. 17, 2014
(86) PCT No.: PCT/JP2014/068981

§ 371 Date: Feb. 8, 2016

(30) Foreign Application Priority Data
Aug. 9, 2013 (JP) 2013-166791

(51) Int. Cl. B60C 3/04; B60C 9/20; B60C 15/00; B60C 9/02

(52) U.S. Cl. CPC B60C 3/04; B60C 9/02; B60C 9/20; B60C 15/00; B60C 2009/2019; B60C 2009/2058; B60C 2009/1828

(57) ABSTRACT

To improve the rolling resistance and air resistance of a tire. It has a belt layer composed of two belt plies in which belt cords are obliquely arranged at mutually opposite angles θ with respect to the tire equator, and a band layer composed of a single band ply in which a band cord is wound spirally in the tire circumferential direction. The angle θ of the belt cords is in a range of 35 degrees˜55 degrees. When Wt is the tire cross sectional width (unit: mm), and Db is a bead diameter (unit: inch), the tire cross sectional width Wt satisfies the following expressions (1), (2).

Wt=<−0.7257×(Db)̂2+42.763×Db−339.67 (1)

Wt>=−0.7257×(Db)̂2+48.568×Db−552.33 (2)

### TECHNICAL FIELD

The present invention relates to a pneumatic tire improved in fuel consumption performance.

### BACKGROUND TECHNIQUE

Tire rolling resistance and air resistance are factors for the fuel consumption of a vehicle. A major cause of the tire rolling resistance is energy loss due to repeated deformation of the rubber during traveling. In order to reduce the rolling resistance, a rubber whose energy loss is small (tan δ is small) has been used as the tread rubber.

However, if a rubber whose energy loss is small is used, although the rolling resistance is reduced, grip performance (especially, wet grip performance) is deteriorated. Further, there is a problem that the wear resistance is deteriorated. As shown in the following Patent Documents 1 and 2, studies on tread rubber compounds capable of reducing the rolling resistance while improving the wear resistance have been carried out. But, to improve the rubber compound only has its limit, therefore, an approach to reduce the rolling resistance from other than the rubber compound is strong demand.

In view of these circumstances, the present inventors conducted the study and could found the following. In the tires having the same outer diameters, if the tire cross sectional width is decreased, the tread width decreases accordingly. Therefore, the rubber volume of the tread rubber is decreased. As a result, the energy loss caused by the tread rubber is reduced, and also a weight reduction of the tire is possible. With the decrease in the tire cross sectional width, the exposed area of the tire, which is exposed downward from the lower edge of a bumper when the vehicle is viewed from its front, is decreased, and the air resistance of the tire can be reduced.

In the tires having the same outer diameters, if the bead diameter is increased, a sidewall region whose deformation during running is large, becomes narrow. As a result, a reduction in the energy loss in a sidewall portion and a weight reduction of the tire can be achieved.

Therefore, it was found that, in the tires having the same outer diameters, a narrow-width large-bead-diameter tire, which is decreased in the tire cross sectional width and increased in the bead diameter, is reduced in the energy loss in the tread portion and the sidewall portion, and reduced in the mass of the tire and the air resistance, and thereby the fuel consumption performance is significantly improved. On the other hand, it has been believed that, in the case of a tire whose belt layer is composed of two belt plies, if the angle of the belt cords (the angle with respect to the tire equator) becomes smaller, the tread profile becomes flatter and the behavior of the tread portion is suppressed, therefore, it is advantageous to the rolling resistance. Thus, the angle of the belt cords is conventionally set at a small angle, for example, about 30 degrees. As a result of the inventors' study, however, it was found that an improvement by the structure can go beyond the deterioration due to the tread profile when the angle of the belt cords is set above a conventional range to some extent, and a large effect to further reduce the rolling resistance can be exhibited.

### PRIOR ART DOCUMENTS

### Patent Document

Patent Document 1: Japanese Patent Application Publication No. 2004-010781
Patent Document 2: Japanese Patent Application Publication No.

### SUMMARY OF THE INVENTION

### Problems that the Invention is to Solve

The problem for the present invention is to provide a pneumatic tire which can further enhance an effect to improve the fuel consumption performance in a narrow-width large-bead-diameter tire essentially by setting belt cords' angles to a value not more than 55 degrees and more than 35 degrees which is larger than conventional values in the narrow-width large-bead-diameter tire.

### Means for Solving the Problems

The present invention is a pneumatic tire having

a carcass extending from a tread portion to a bead core in a bead portion through a sidewall portion,

a belt layer disposed radially outside the carcass in the tread portion, and composed of two belt plies in which belt cords are obliquely arranged at mutually opposite angles θ with respect to the tire equator,

a band layer disposed radially outside the belt layer in the tread portion, and composed of a single band ply in which a band cord is wound spirally in the tire circumferential direction, and characterized in that

when Wt is the tire cross sectional width (unit: mm), and Db is a bead diameter (unit: inch), the tire cross sectional width Wt satisfies the following expressions (1), (2)

Wt=<−0.7257×(Db)̂2+42.763×Db−339.67 (1)

Wt>=−0.7257×(Db)̂2+48.568×Db−552.33 (2)

and

the angles θ of the belt cords are in a range of 35˜55 degrees.

In the pneumatic tire according to the present invention, it is preferable that the angles θ of the belt cords are 45 degrees˜55 degrees.

In the pneumatic tire according to the present invention, it is preferred that, when Ea is a tensile rigidity of a belt cord in an elongation range of 0.4%˜1.0%, and Na is an end count of the belt cords per 1 mm ply width in the perpendicular direction to the belt cords in the first, second belt ply, a ply rigidity of the belt ply which is a product (Ea×Na) of the tensile rigidity Ea and the end count Na is 14000˜20000 N/mm.

In the pneumatic tire according to the present invention, it is preferred that, when Eb is a tensile rigidity of a band cord in an elongation range of 3%˜5%, and Nb is a end count of band cords per 1 mm ply width in the perpendicular direction to the band cords in the band ply,

a ply rigidity of the band ply which is a product (Eb×Nb) of the tension rigidity Eb and the end count Nb is 1600˜2500 N/mm.

In the pneumatic tire according to the present invention, it is preferable that the tire outer diameter Dt (unit: mm) satisfies the following expressions (4), (5)

Dt=<59.078×Wt̂0.498 (4)

Dt>=59.078×Wt̂0.467 (5).

In this specification, unless otherwise noted, dimensions of respective parts of the tire refer to values determined in a non-rim assembled state in which the bead portions are held with a rim width determined by the size of the tire.

In this specification, a range of not less than T1 and not more than T2 is expressed as T1˜T2.

### Effect of the Invention

As described above, the pneumatic tire according to the present invention is formed as a narrow-width large-bead-diameter tire whose cross sectional width Wt satisfies the above-mentioned expressions (1), (2). Therefore, reduction of the energy loss in the tread portion and the sidewall portion, reduction of the tire weight, and reduction of the air resistance can be achieved, and it is possible to improve the fuel consumption performance.

Moreover, in the pneumatic tire, the angles θ of the belt cords are set in the range of 35 degrees˜55 degrees. As a result, as described in the section “Mode for carrying out the Invention”, it becomes possible to further improve the rolling resistance, while suppressing cracking damage TGC (Tread Groove Cracking) in the bottoms of lug grooves provided in the tread portion.

### BRIEF DESCRIPTION OF THE DRAWINGS

FIG. 1 A cross sectional view showing an example of the pneumatic tire of the present invention.

FIG. 2 A graph in which relationships between cross-sectional widths and bead diameters of conventional tires shown in JATM are plotted.

FIG. 3 A graph in which relationships between cross-sectional widths and outer diameters of conventional tires shown in JATM are plotted.

FIG. 4 A diagram for explaining the effect of enlargement of the tire diameter.

FIG. 5 A developed plan view showing the cords' arrangement of the belt layer.

FIG. 6 (A) is a graph showing a relationship between the angle of the belt cords and the shearing rigidity of the belt layer, (B) is a graph showing a relationship between the angle of the belt cords and the Poisson's ratio of the belt layer.

FIG. 7 (A), (B) are graphs showing strain in the tire axial direction of a tread rubber, and strain in the tire axial direction of the belt layer, at the tire equator, when the tire is rolling.

FIG. 8 (A), (B) are graphs showing strain in the tire axial direction of the tread rubber, and strain in the tire axial direction of the belt layer, in a tread shoulder, when the tire is rolling.

FIG. 9 A graph of “load-elongation curve” for explaining the tensile rigidity of a cord.

FIG. 10 A graph showing relationships among the band ply rigidity, the belt layer's ply rigidity, the energy loss of the tread rubber and the energy loss of the topping rubber.

### MODE FOR CARRYING OUT THE INVENTION

Hereinafter, an embodiment of the present invention will be described in detail.

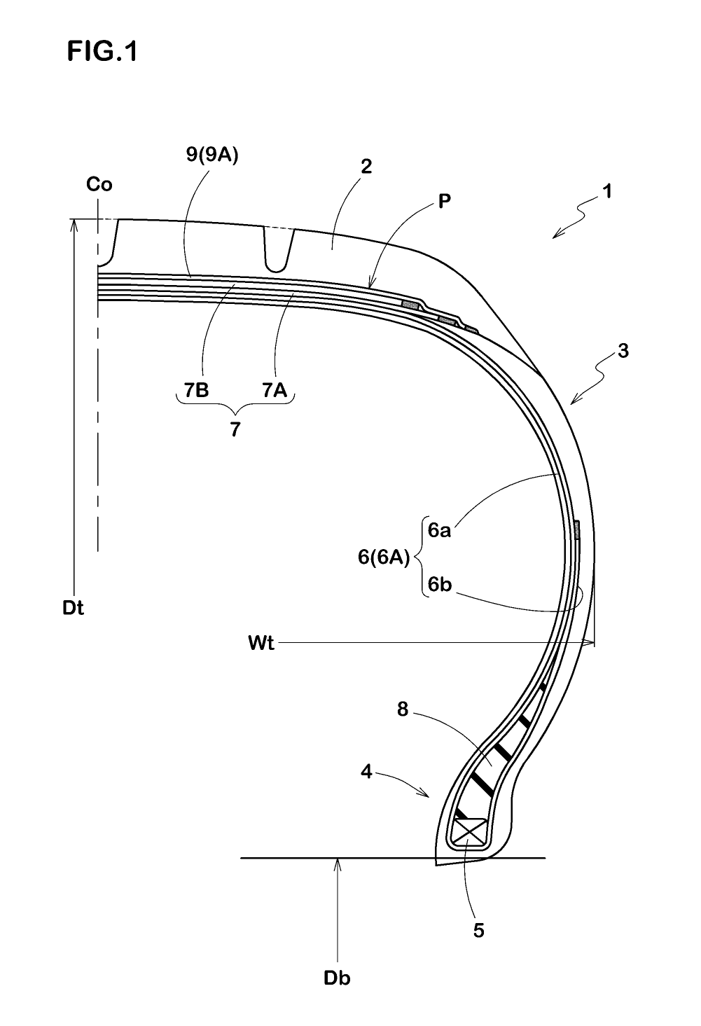

As shown in the FIG. 1, the pneumatic tire 1 in this embodiment has a carcass 6 extending from a tread portion 2 to a bead core 5 in a bead portion 4 through a sidewall portion 3, a belt layer 7 disposed radially outside the carcass 6 in the tread portion 2, and a band layer 9 disposed radially outside the belt layer 7 in the tread portion 2.

In this example, the pneumatic tire 1 is a radial tire for passenger cars.

Given that Wt is the tire cross sectional width (unit: mm), and Db is a bead diameter (unit: inch), the pneumatic tire 1 is formed as a narrow-width large-bead-diameter tire whose cross sectional width Wt satisfies the following expressions (1), (2)

Wt=<−0.7257×(Db)̂2+42.763×Db−339.67 (1)

Wt>−0.7257×(Db)̂2+48.568×Db−552.33 (2).

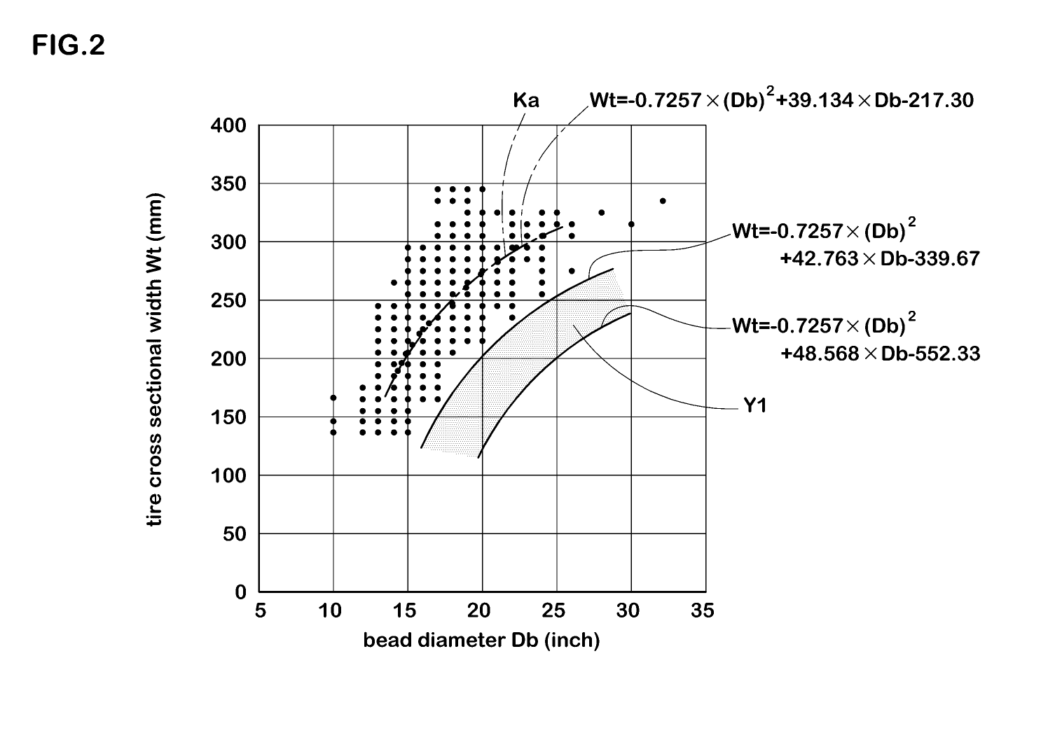

The FIG. 2 is a graph in which results of a research are plotted. The research was performed about relationships between tire cross-sectional widths Wt and bead diameters Db of conventional tires shown in JATM. From the results of research, an average relationship between the cross sectional widths Wt and the bead diameters Db of the conventional tires shown in JATM can be expressed by the following expression (A) as indicated by one-dot chain line Ka in the figure

Wt=−0.7257×(Db)̂2+39.134×Db−217.30 (A).

In contrast, a region Y1 satisfying the expressions (1), (2) is outside the plotted range of the conventional tires, and located in such position that the average relationship Ka expressed by the expression (A) is translated to a direction toward which the tire cross sectional width Wt is decreased and also to a direction toward which the bead diameter Db is increased. That is, a tire which satisfies the expressions (1), (2) is a narrow-width large-bead-diameter tire in which the tire cross sectional width Wt is reduced and the bead diameter Db is increased in comparison with the conventional tires having the same tire outer diameter.

In such tire, as the tire cross sectional width is narrow, the tread width is also decreased, and accordingly, the amount of rubber in the tread rubber is also decreased. Therefore, the amount of energy loss by the tread rubber is relatively reduced, and further, the mass of the tire is also reduced. Further, the area of the tire exposed downward from the lower edge of a bumper when the vehicle is viewed from the front is reduced with the decrease in the tire cross sectional width. Therefore, it is possible to reduce the air resistance of the tire during running.

Further, since the bead diameter is large in comparison with the conventional tires having the same tire outer diameter, the sidewall region whose deformation during running is large, becomes narrower. As a result, the energy loss in the sidewall portion 3 is lessened, and the mass of tire is reduced.

In the narrow-width large-bead-diameter tire, therefore, owing to the reduction in the energy loss in the tread portion 2 and the sidewall portions 3, the reduction in the mass of the tire, and the reduction in the air resistance, it is possible to improve the fuel efficiency of the tire.

If the tire cross sectional width Wt is out of the expression (2), the reducing of the width and the increasing of the bead diameter become excessively less, and the improvement of the fuel efficiency becomes insufficient. If out of the expression (1), the width is excessively decreased, and it becomes necessary to set a high pressure to the in-use pressure in order to secure a necessary load capacity, therefore, the ride comfort performance and road noise performance are negatively affected.

In order to further improve the fuel efficiency, it is preferred that the tire outer diameter Dt (unit: mm) of the he pneumatic tire 1 satisfies the following expressions (4), (5)

Dt=<59.078×Wt̂0.498 (4)

Dt>=59.078×Wt̂0.467 (5).

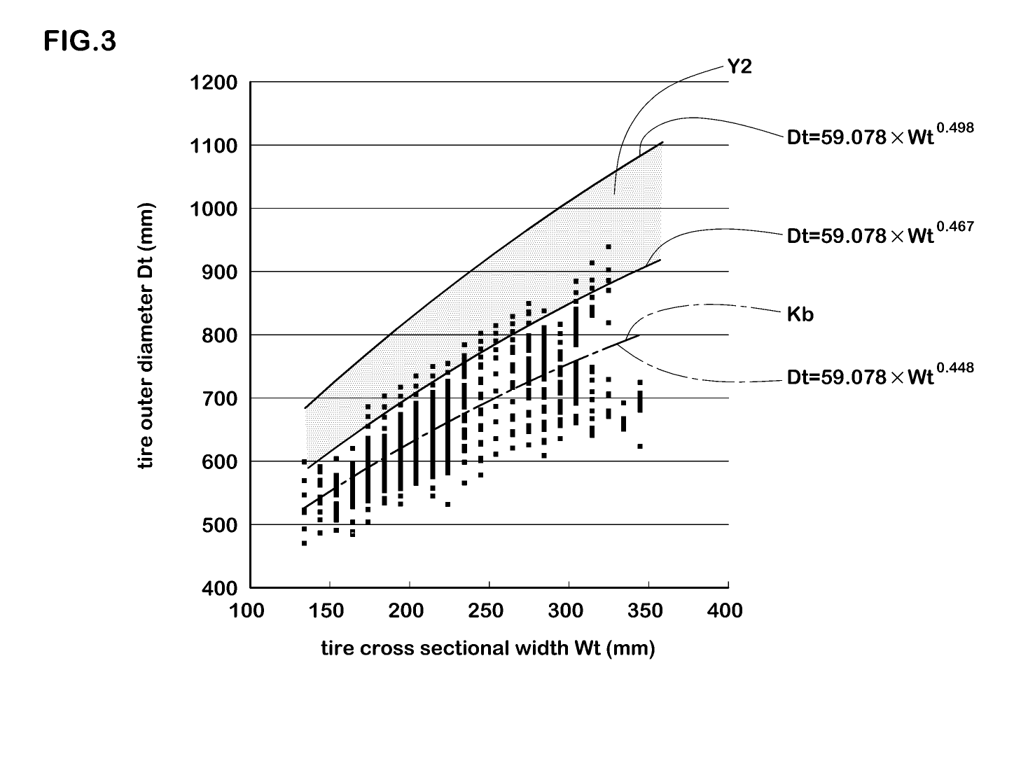

The FIG. 3 is a graph in which results of a research performed about relationships between the tire cross sectional widths Wt and the tire outer diameters Dt of the conventional tires shown in JATM, are plotted. From the results of the research, the average relationship between the tire cross sectional widths Wt and the tire outer diameters Dt of the conventional tires shown in JATM, can be expressed by the following expression (B) as indicated in the figure by one-dot chain line Kb:

Dt=59.078×Wt̂0.448 (B).

In contrast, the region Y2 satisfying the expression (4), (5), is located in such position that the average relationship Kb expressed by the expression (B) is translated to a direction toward which the tire outer diameter Dt is increased. That is, the tire further satisfies the expression (4), (5) is a narrow-width large-bead-diameter tire whose tire outer diameter Dt is large.

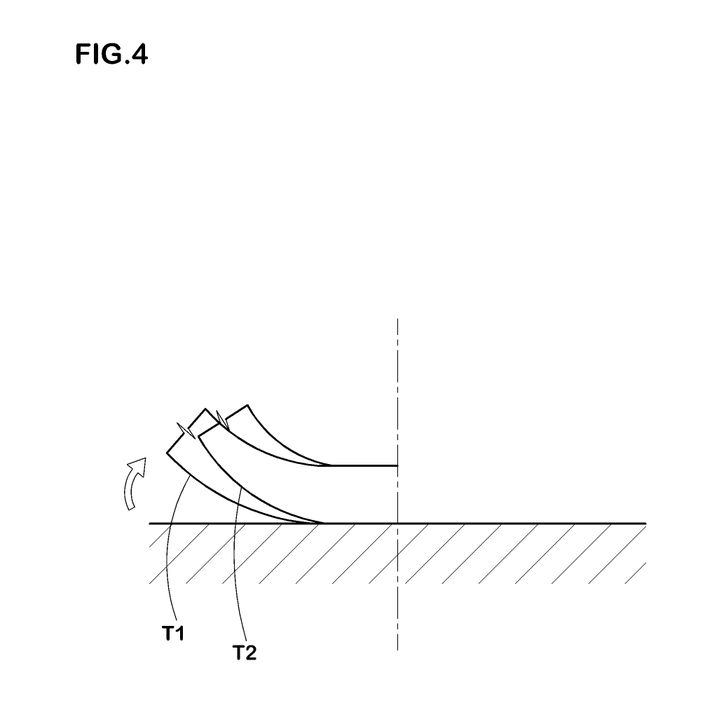

In the case of a tire T1 whose outer diameter Dt is relatively large, in compression with a tire T2 whose outside diameter Dt is small, circumferential bending deformation of the ground contacting patch is smaller as shown conceptually in the FIG. 4. Therefore, the energy loss is small, which is effective for reducing the rolling resistance. If out of the expression (5), it can not be expected to reduce the rolling resistance by increasing the tire diameter. If out of the expression (4), in order to secure a necessary load capacity, it is necessary to set a high pressure to the in-use pressure, therefore, the riding comfort performance and road noise performance are adversely affected.

From the viewpoint of the rolling resistance, the aspect ratio of the tire is preferably in a range of 55%˜70%. If the aspect ratio of the tire is less than 55%, the tread width becomes wide, and accordingly, tread members such as tread rubber also increase, therefore, the energy loss is liable to increase. If the aspect ratio of the tire is more than 70%, the percentage of the sidewall members increases, and thereby, the energy loss is liable to increase.

The load index LI of the pneumatic tire 1 in this example is set in a range of the load index LIO of a reference tire+3˜the load index LIO−10.

The width WtO of the reference tire is determined as a nominal width closest to a value w which is calculated by the following expression (6) using the aspect ratio H of the tire.

W=0.0098×Ĥ2−2.9758×H+343.69 (6)

The rim diameter DrO of the reference is determined as an integer nearest to a value Dr calculated by the following expression (7) using the aspect ratio H (unit: %) of the tire.

Dr=0.002×Ĥ2−0.3547×H+29.783 (7)

For example, if the aspect ratio H of the tire is 60%,

W=0.0098×60̂2−2.9758×60+343.69=203

from the expression (6). Therefore, the tire width WtO is determined as 205 which is a nominal width nearest to 203. From the expression (7),

Dr=0.002×60̂2−0.3547×60+29.783=15.7.

Therefore, the rim diameter DrO is determined as 16 which is the nearest integer to 15.7. That is, the tire size of the reference tire is 203/60R16.

The load index LIO of the reference tire is a load index described in the TIRE SIZE specified by TATMA. If a plurality of load indexes LIO are described, the lowest value of them is used.

Next, as shown in the FIG. 1, the carcass 6 of the pneumatic tire 1 is composed of at least one ply, in this example, a single carcass ply 6A of carcass cords arranged at, for example, an angle of 75˜90 degrees with respect to the tire equator co.

The carcass ply 6A has, at each end of a toroidal ply main portion 6a extending between the bead cores 5, 5, a ply turnup portion 6b folded back around the bead core 5 from the inside to the outside in the tire axial direction. Between the ply main portion 6a and the ply turnup portion 6b, there is disposed a bead apex rubber 8, for reinforcing the bead, extending from the bead core 5 toward the outside in the tire radial direction in a tapered shape.

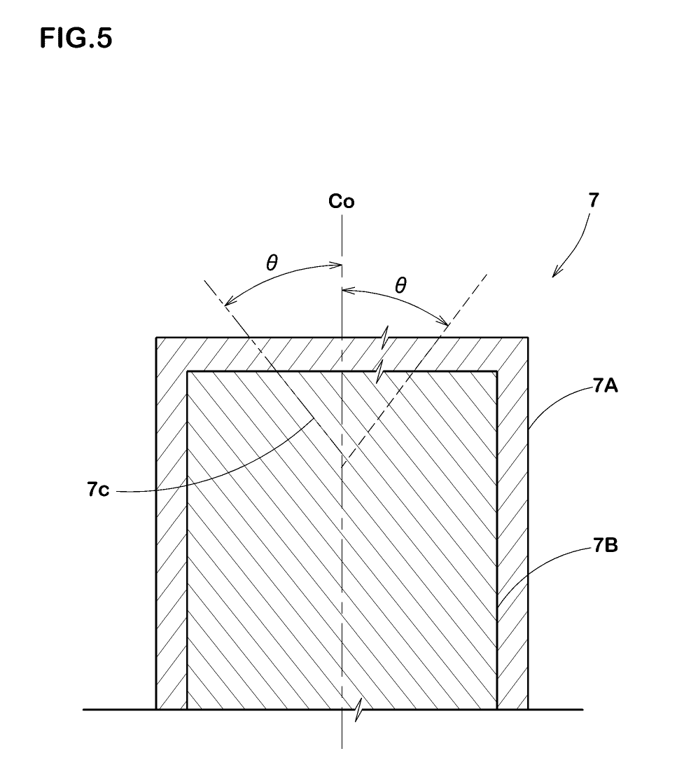

The belt layer 7 is, as shown in the FIG. 5, composed of two belt plies 7A, 7B of belt cords 7c obliquely arranged in opposite directions with respect to the tire equator Co. That is, the belt layer 7 forms a bias structure in which the belt cords mutually intersect between the plies, and firmly reinforces an almost entire width of the tread portion 2. The angle θ with respect to the tire equator co of the belt cords 7c is set to an angle of 35˜55 degrees which is larger than before.

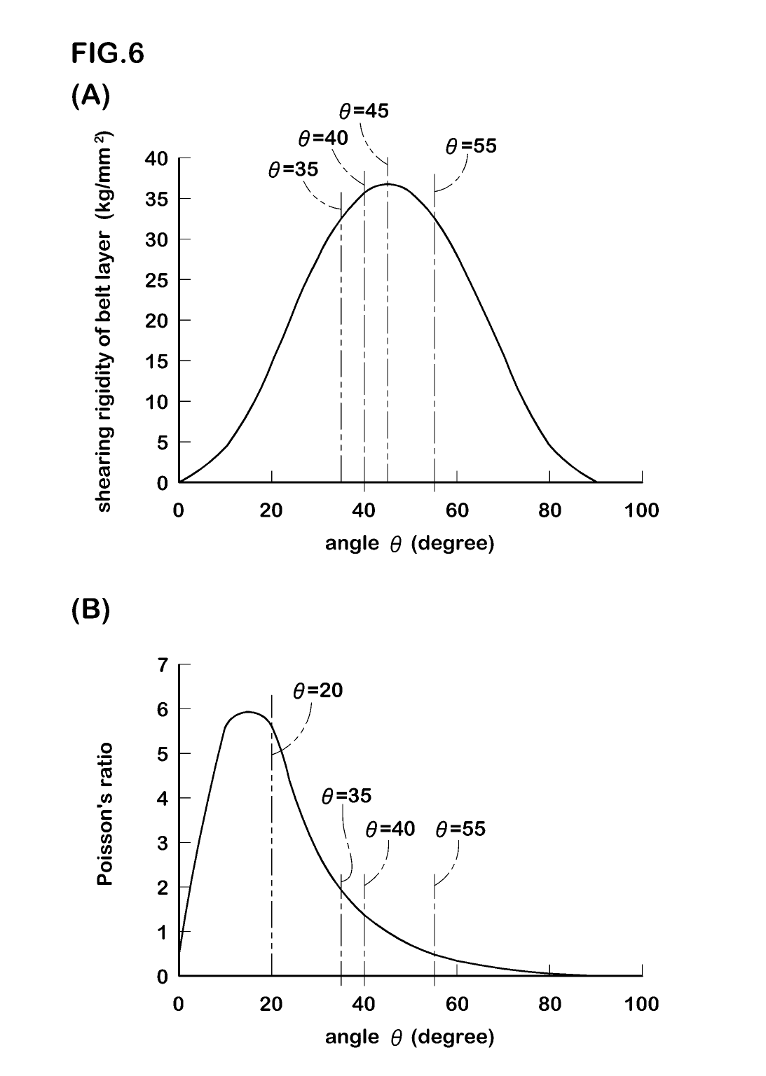

In the FIG. 6 (A), there is shown a relationship between the angle θ of the belt cords 7c and the shearing rigidity of the belt layer 7.

In the FIG. 6 (B), there is shown a relationship between the angle θ of the belt cords 7c and the Poisson's ratio of the belt layer 7.

In the tread portion 2, since the shearing rigidity of the belt layer 7 is high, the amount of deformation at the time of rolling is suppressed. Therefore, from the viewpoint of the rolling resistance, it is preferable that the shearing rigidity of the belt layer 7 is higher.

On the other hand, the Poisson's ratio refers to the ratio of the amount of deformation in the tire circumferential direction of the belt layer 7 when pulled in the tire circumferential direction, and the amount of deformation in the tire axial direction (widthwise direction).

In the tire, when contacting with the ground, the belt layer 7 is pulled in the tire circumferential direction. At that time, if the Poisson's ratio is large, the behavior in the tire axial direction of the tread portion 2 is increased, which leads to an increase in the energy loss. Therefore, from the viewpoint of the rolling resistance, it is preferable that the Poisson's ratio is smaller.

In the FIG. 6 (A), the shearing rigidity becomes a maximum value when θ=45 degrees, and

a high shearing rigidity close to the maximum value is shown when in a range of 35˜55 degrees.
On the other hand, the Poisson's ratio becomes a maximum value when θ approximately equals to 15 degrees, and the Poisson's ratio decreases from the maximum value with increase in θ. Especially, the slope is steep between 20˜35 degrees, and becomes a mild-slope gradually from 35 degrees. Thus, the range of 35˜55 degrees is a range where the shearing rigidity is large and the Poisson's ratio is a small, and the effect to reduce the rolling resistance can be obtained.

In a range of 35˜40 degrees which is within the range of 35˜55 degrees, the shearing rigidity is high to the same extent as in a range of 50˜55 degrees, and the Poisson's ratio becomes relatively increased. Therefore, the behavior in the tire axial direction of the tread portion 2 is slightly larger, and the effect to reduce the rolling resistance becomes relatively decreased.

Within the range of 35˜55 degrees, therefore, a range of more than 40 degrees in which the Poisson's ratio becomes smaller, in particular, a range of not less than 45 degrees, is preferred. If the angle θ exceeds 55 degrees, although the Poisson's ratio is small, the effect to reduce the rolling resistance can not be sufficiently exhibited because the shear rigidity is excessively reduced. Moreover, due to the decreased shear rigidity, the radially outward lifting of the tread portion 2 is increased. Therefore, when the tread portion 2 is provided with lug grooves, there is a tendency to cause crack damage such as cracks in the bottoms of the grooves.

In order to test the effect of the angle θ on the rolling resistance, passenger car tires (tire size 165/65R19) having the structure shown in the FIG. 1 were manufactured, changing the angle θ of the belt cords only. The angles θ of the test tires are 24 degrees and 45 degrees only.

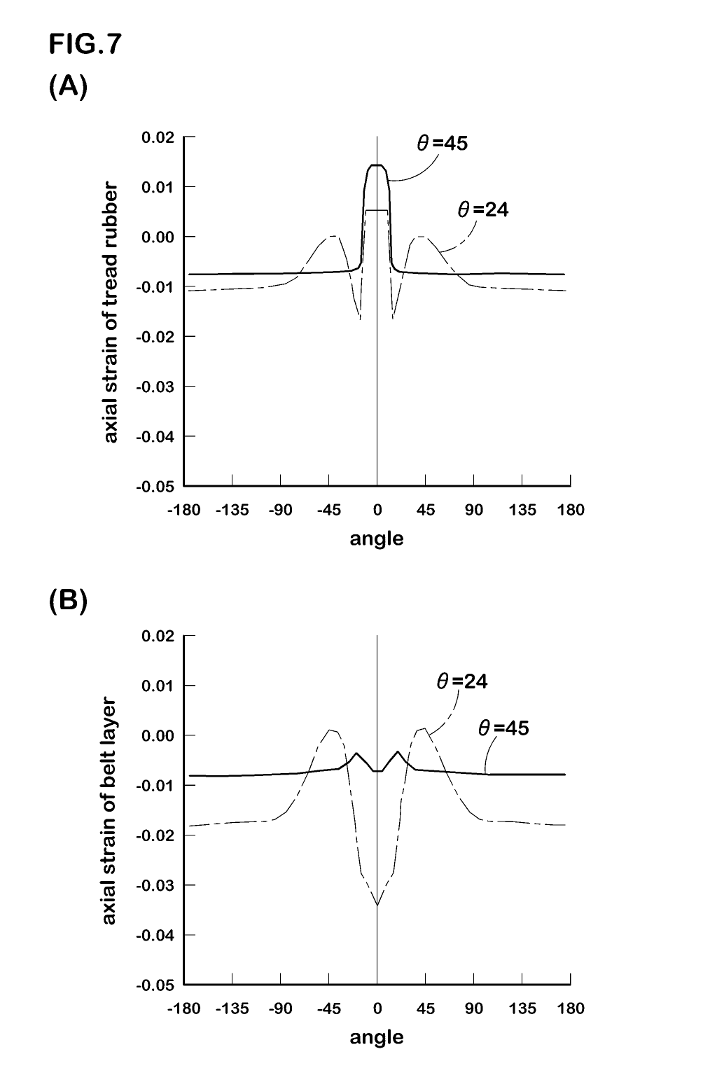

The strain in the tire axial direction of the tread rubber and the strain in the tire axial direction of the belt layer 7 of the tire when rotated −180 degrees˜180 degrees under the conditions: a rim (5J×19), an internal pressure (310 kPa), a longitudinal load (4.8 kN), were calculated at the position of the tire equator co by a finite element method, and the results are shown in FIG. 7 (A), (B).

The calculated position for the strain of the tread rubber was the thickness center of the tread rubber. The calculated position for the strain of the belt layer 7 was a position between the belt plies 7A, 7B.

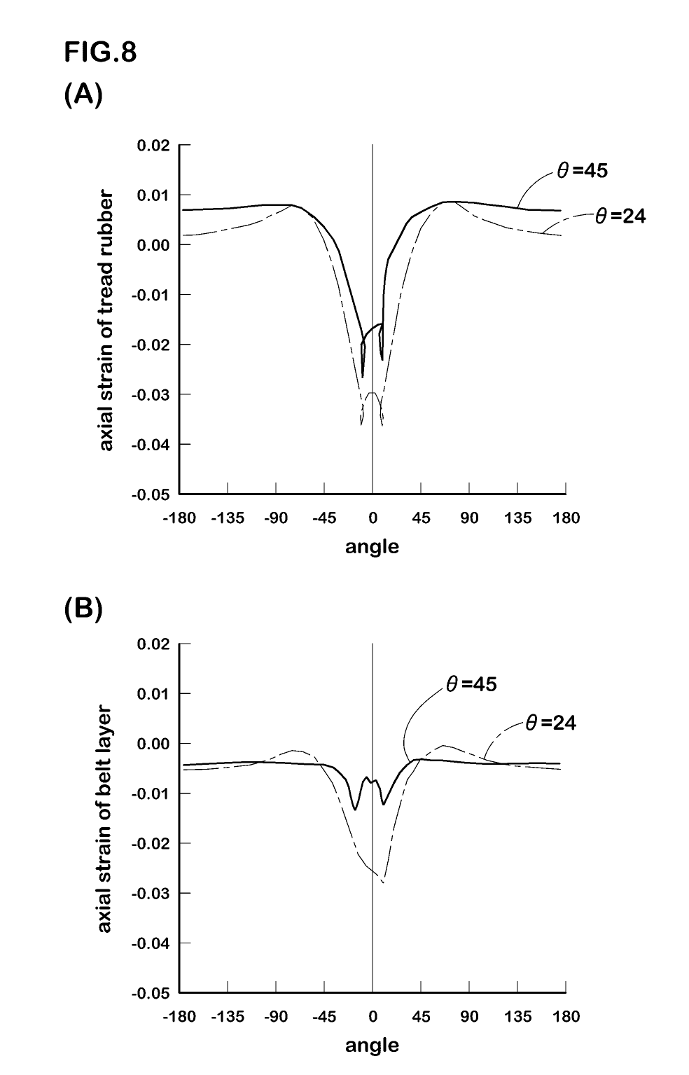

Similarly, the strain in the tire axial direction of the tread rubber and the strain in the tire axial direction of the belt layer 7 of the tire when rotated −180 degrees˜180 degrees were measured at a position P in the tread shoulder (shown in the FIG. 1), and the results are shown in FIG. 8 (A), (B). As shown in the same figures, it can be confirmed that, at each position of the tire equator and the tread shoulder, the tire with θ=45 degrees was smaller in the amplitude of the strain in the tire axial direction and less in the energy loss when compared with the tire with θ=24 degrees.

In the pneumatic tire 1, it is preferable that a ply rigidity in the belt ply 7A, 7B (sometimes referred to as the “belt ply rigidity”) is in a range of 14000˜20000 N/mm. Further, it is preferable that a ply rigidity in the band ply 9A (sometimes referred to as the “band ply rigidity”) is in a range of 1600˜2500 N/mm.

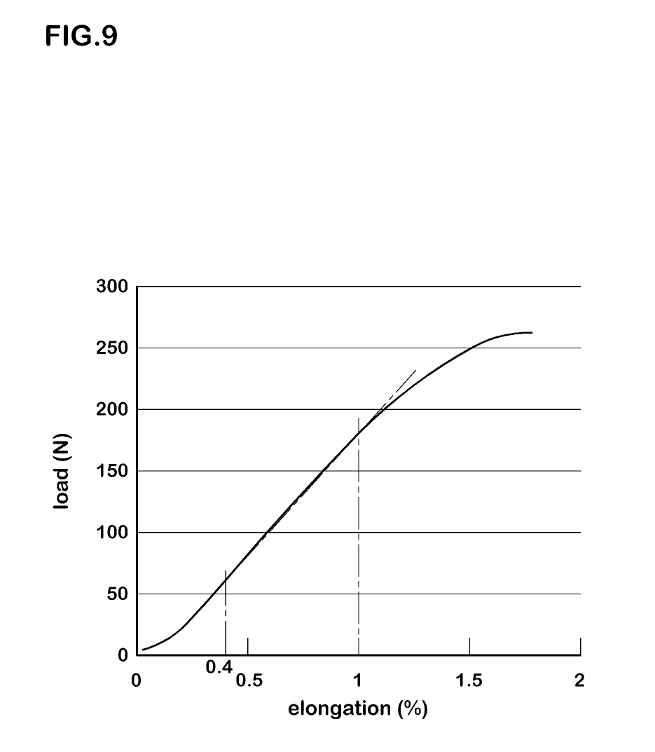

The belt ply rigidity is defined by the product (Ea×Na) of the tensile rigidity Ea of one belt cord and the end count Na of the belt cords. The end count Na means the number of the belt cords per 1 mm ply width of the belt ply in the perpendicular direction to the belt cords. The tensile rigidity Ea is a tensile rigidity in a range of 0.4%˜1.0% elongation of the cord. The tensile rigidity Ea is a load per 1% elongation obtained from the inclination of the “elongation-load curve” of the cord between 0.4% and 1.0% elongation as illustrated in the FIG. 9.

The band ply rigidity is defined by the product (Eb×Nb) of the tensile rigidity Eb of one band cord and the end count Nb of the band cord. The end count Nb means the number of the band cords per 1 mm ply width of the band ply in the perpendicular direction to the band cords. The tensile rigidity Eb is a tensile rigidity in a range of 3%˜5% elongation of the cord. The tensile rigidity Ea is a load per 1% elongation obtained from the inclination of the “elongation-load curve” of the cord between 3% and 5% elongation.

Heretofore, it has been considered that, if the belt ply rigidity becomes larger, the deformation of the tread portion 2 becomes smaller, and the rolling resistance is reduced. As a result of the inventor's research, however, it was found that the effect to reduce the rolling resistance appears when the belt ply rigidity is in a range smaller than before.

The reason for this is presumed as follows. During running of the tire, the belt layer 7 is bent in the circumferential direction, generating a force in the longitudinal direction of the belt cord, and shearing deformation occurs in the belt layer.

In this case, if the belt ply rigidity is low, it is presumed that the shearing deformation of the belt layer 7 becomes small, and the behavior of the tread rubber disposed on the belt layer 7 becomes decreased.

However, if the belt ply rigidity is low, the radially outward swelling of the tread portion 2 by the inflation of the tire, is increased. As a result, there is concern that crack damage occurs in the bottoms of the lag grooves.

In the present invention, however, the angle θ of the belt cords is set to 35 degrees or more, therefore, the behavior in the tire axial direction of the tread portion 2 becomes less than before. Therefore, the strain at the lug groove bottom is reduced, and the crack damage is suppressed. That is, by setting the angle θ of the belt cords to 35 degrees or more, it is possible to make the belt ply rigidity lower than before. Therefore, the effect to reduce the rolling resistance by the angle θ and the effect to reduce the rolling resistance by the belt ply rigidity can be brought out.

If the belt ply rigidity exceeds 21000 N/mm, the effect to reduce the rolling resistance can not be effectively exerted. If less than 15000 N/mm, although it is preferable for the rolling resistance, it becomes difficult to suppress the crack damage in the lug groove bottom.

Next, when the tread portion 2 enters in the ground contact patch, since the tread portion 2 is bent in the circumferential direction, a tensile deformation occurs in the band layer 9 and a compressive deformation occurs in the belt layer 7. Therefore, if the band ply rigidity is high, a force more easily acts on the belt layer 7. Therefore, deformation of the topping rubber of the belt layer 7 is increased, and the amount of energy loss is increased. However, since the band ply rigidity is increased, the deformation of the band layer 9 itself is suppressed, and the energy loss of the tread rubber disposed thereon is reduced. That is, if the band ply rigidity is increased, although the energy loss of the topping of the belt layer 7 is increased, the energy loss of the tread rubber is decreased.

In other words, the band ply rigidity has a range which is suitable for reducing the sum of the energy loss of the tread rubber and the energy loss of the topping. The suitable range is 1600˜2500 N/mm.

If the band ply rigidity becomes out of the above range, the sum of the energy loss becomes increased, which is disadvantageous to the rolling resistance. If the band ply rigidity becomes less than 1600 N/mm, the hoop effect becomes insufficient, which is disadvantageous to the crack damage in the lug groove bottom.

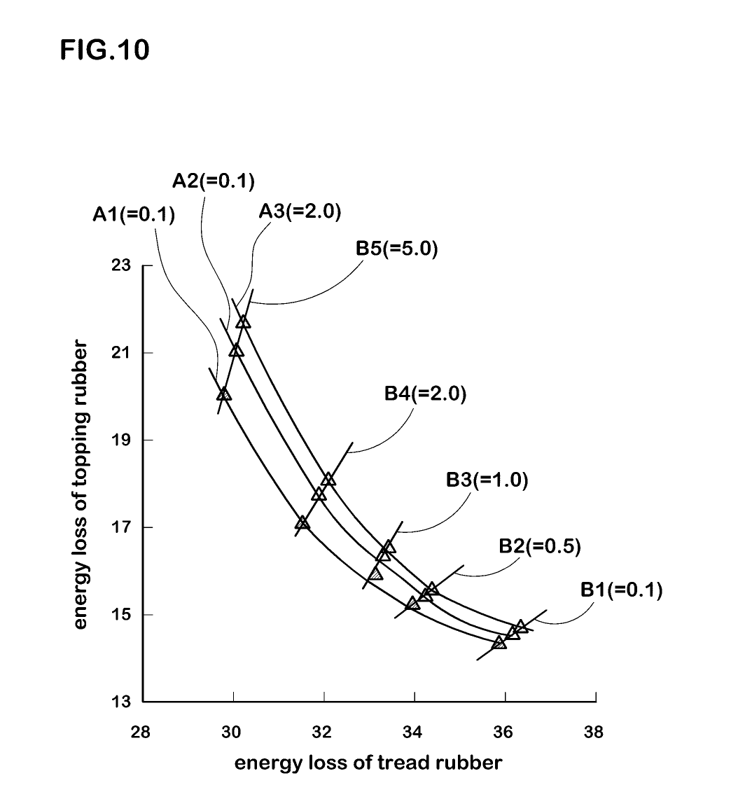

The FIG. 10 shows calculation results about the energy loss of the tread rubber and topping rubber (of the belt layer and the band layer) which were obtained by simulating tires prepared by combining five band layers having different band ply rigidities B1-B5 with three belt layers having different belt ply rigidities A1-A3.

In the figure, the value of the band ply rigidity B1-B5, the value of the belt ply rigidity A1-A3, the value of the energy loss of the tread rubber, and the value of the energy loss of the topping rubber are each indicated by an index.

As shown in the same figure, it can be seen that, with increase in the band ply rigidity B, the energy loss of the tread rubber decreases, whereas the energy loss of the topping rubber increases.

As to the belt ply rigidity A, it can be seen that, with increase in the belt ply rigidity A, both of the energy loss of the tread rubber and the energy loss of the topping rubber increase.

While detailed description has been made of an especially preferable embodiment of the present invention, the present invention can be embodied in various forms without being limited to the illustrated embodiment.

### Working Examples

(1) Pneumatic tires having the internal structure shown in the FIG. 1 were experimentally manufactured according to specifications shown in Table 1, and

each test tire was tested for the rolling resistance, air resistance and ride comfort.

The angle θ of the belt cords=41 degrees, the belt ply rigidity Ea/Na=24275 N/mm, and the band ply rigidity Eb/Nb=827 N/mm, which were common to all of the tires. Only the tire cross sectional width Wt, bead diameter Db, and outside tire diameter Dt were differed.

### <Rolling Resistance>

Using a rolling resistance tester, the rolling resistance (unit N) of the tire was measured under the following conditions, and its inverse is indicated by an index based on comparative Example 1 being 100. The larger the number, the smaller or better the rolling resistance.
temperature: 20 degrees C.
load: 4.8 kN
internal pressure: listed in Table 1
rim: regular rim
speed: 80 km/h

### <Air Resistance>

In a laboratory, air corresponding to a running speed of 100 km/h was sent to an exposed surface of the tire after the height exposed from the lower edge of a bumper was set to 140 mm, and the force which the tire was received from the air at that time was measured. As the evaluation, the reciprocal of the measured value is indicated by an index based on Comparative Example 1 being 100. The large the number, the smaller or better the air resistance.

### <Ride Comfort>

The vertical spring constant of the test tire was measured, and its inverse is indicated by an index based on comparative Example 1 being 100. The larger the number, the better the ride performance.

TABLE 1

| | Comparative | Comparative | Working | Working | Working | Working |
|---|---|---|---|---|---|---|
| | example 1 | example 2 | example 1 | example 2 | example 3 | example 4 |
| tire cross sectional width Wt (mm) | 195 | 165 | 165 | 165 | 165 | 165 |
| aspect ratio H (%) | 65 | 65 | 65 | 65 | 65 | 65 |
| bead diameter Db (inch) | 15 | 16 | 18 | 19 | 20 | 22 |
| load index LI | 91 | 81 | 84 | 85 | 86 | 88 |
| inner pressure (Kpa) | 250 | 350 | 320 | 310 | 300 | 280 |
| rim width (inch) | 6 | 5 | 5 | 5 | 5 | 5 |
| tire outer diameter Dt (mm) | 630.0 | 616.1 | 666.3 | 691.4 | 716.5 | 766.7 |
| Rolling resistance | 100 | 102 | 103 | 104 | 104 | 104 |
| Ride comfort | 100 | 92 | 93 | 90 | 94 | 80 |
| Air resistance | 100 | 114 | 114 | 114 | 114 | 116 |

| | Working | Working | Working | Working | Comparative |
|---|---|---|---|---|---|
| | example 5 | example 6 | example 7 | example 8 | example 3 |
| tire cross sectional width Wt (mm) | 165 | 155 | 185 | 185 | 155 |
| aspect ratio H (%) | 65 | 65 | 65 | 65 | 65 |
| bead diameter Db (inch) | 21 | 18 | 21 | 19 | 22 |
| load index LI | 87 | 80 | 94 | 92 | 85 |
| inner pressure (Kpa) | 290 | 360 | 220 | 240 | 310 |
| rim width (inch) | 5 | 4.5 | 5.5 | 5.5 | 4.5 |
| tire outer diameter Dt (mm) | 741.6 | 653.3 | 767.6 | 717.4 | 753.7 |
| Rolling resistance | 104 | 103 | 101 | 102 | 106 |
| Ride comfort | 90 | 90 | 90 | 90 | 75 |
| Air resistance | 115 | 120 | 102 | 105 | 120 |

| | Working | Working | Working | Comparative |
|---|---|---|---|---|
| | example 9 | example 10 | example 11 | example 4 |
| tire cross sectional width Wt (mm) | 135 | 195 | 155 | 215 |
| aspect ratio H (%) | 80 | 55 | 70 | 50 |
| bead diameter Db (inch) | 19 | 19 | 19 | 19 |
| load index LI | 78 | 90 | 84 | 93 |
| inner pressure (Kpa) | 380 | 260 | 320 | 230 |
| rim width (inch) | 3.5 | 6 | 4.5 | 7 |
| tire outer diameter Dt (mm) | 692.9 | 691.4 | 693.9 | 691.9 |
| Rolling resistance | 102 | 102 | 103 | 95 |
| Ride comfort | 85 | 95 | 88 | 104 |
| Air resistance | 125 | 100 | 120 | 90 |

(2) Taking the working Example 2 (165/65R19) in Table 1 as the reference tire (corresponding to Example 3A in Table 2), tires were experimentally manufactured by changing only the angle θ of the belt cords, belt ply rigidity Ea/Na, band ply rigidity Eb/Nb according to the specifications shown in Table 2, and tested for the rolling resistance and crack damage in the lug groove bottom (TGC).

### <TGC>

In the bottoms of circumferential grooves and lug grooves disposed in the tread portion, cuts having 8 mm length and 2 mm depth were formed by the use of a razor blade having 0.25 mm thickness, and the shapes of the opened cuts were copied and measured.

The tire was run on the drum for 10000 km with a rim (5.03×19), internal pressure (310 kPa) and load (4.8 kN), and the dimensions of the cuts were compared with the dimensions of the cuts copied before running in order to obtain their increases, and the reciprocals thereof are indicated by an index based on the reference tire being 100. The larger the value, the better the resistance to crack damage.

TABLE 2

| | | Working | Working | Working | Working | Working |
|---|---|---|---|---|---|---|
| | Comparative | example | example | example | example | example |
| | example 1A | 1A | 2A | 3A | 4A | 5A |
| belt ply rigidity Ea/Na (N/mm) | 24275 | 24275 | 24275 | 24275 | 24275 | 24275 |
| band ply rigidity Eb/Nb (N/mm) | 827 | 827 | 827 | 827 | 827 | 827 |
| belt cord angle θ (degree) | 24 | 35 | 40 | 41 | 45 | 55 |
| Rolling resistance | 100 | 102 | 103 | 104 | 105 | 105 |
| TGC | 102 | 100 | 100 | 100 | 99 | 98 |

| | | Working | Working | Working | Working |
|---|---|---|---|---|---|
| | Comparative | example | example | example | example |
| | example 2A | 6A | 7A | 8A | 9A |
| belt ply rigidity Ea/Na (N/mm) | 24275 | 20000 | 16452 | 14000 | 13161 |
| band ply rigidity Eb/Nb (N/mm) | 827 | 827 | 827 | 827 | 827 |
| belt cord angle θ (degree) | 60 | 45 | 45 | 45 | 45 |
| Rolling resistance | 104 | 106 | 107 | 108.5 | 109 |
| TGC | 95 | 100 | 99 | 98 | 97 |

| | Working | Working | Working | Working | Working | Working |
|---|---|---|---|---|---|---|
| | example | example | example | example | example | example |
| | 10A | 11A | 12A | 13A | 14A | 15A |
| belt ply rigidity Ea/Na (N/mm) | 16452 | 16452 | 16452 | 16452 | 16452 | 16452 |
| band ply rigidity Eb/Nb (N/mm) | 1500 | 1600 | 2242 | 2500 | 2600 | 3085 |
| belt cord angle θ (degree) | 45 | 45 | 45 | 45 | 45 | 45 |
| Rolling resistance | 107 | 107 | 106.5 | 106 | 105.5 | 105 |
| TGC | 100 | 100.8 | 101 | 101 | 101 | 101.5 |

As shown in Tables, it can be confirmed that the working Example tires were improved in the fuel consumption performance (rolling resistance and air resistance).

### DESCRIPTION OF THE REFERENCE NUMERALS

1 pneumatic tire
2 tread portion
3 sidewall portion
4 bead portion
5 bead core
6 carcass
7 belt layer
7A, 7B belt ply
7c belt cord
9 band layer
9A band ply
Co tire equatorial plane
Pm maximum width position

1. A pneumatic tire having
a carcass extending from a tread portion to a bead core in a bead portion through a sidewall portion,
a belt layer disposed radially outside the carcass in the tread portion, and composed of two belt plies in which belt cords are obliquely arranged at mutually opposite angles θ with respect to the tire equator,
a band layer disposed radially outside the belt layer in the tread portion, and composed of a single band ply in which a band cord is wound spirally in the tire circumferential direction, and characterized in that
when Wt is the tire cross sectional width (Unit: mm), and Db is a bead diameter (Unit: inch),
the tire cross sectional width Wt satisfies the following expressions (1), (2)
Wt=<−0.7257×(Db)̂2+42.763×Db−339.67 (1)
Wt>=−0.7257×(Db)̂2+48.568×Db−552.33 (2)
and
the angles θ of the belt cords are in a range of 35˜55 degrees.

2. The pneumatic tire as set forth in claim 1, characterized in that the angles θ of the belt cords are 45 degrees˜55 degrees.

3. The pneumatic tire as set forth in claim 1, characterized in that, when Ea is a tensile rigidity of a belt cord in an elongation range 0.4%˜1.0%, and Na is a end count of belt cords per 1 mm ply width in the perpendicular direction to the belt cords in the first, second belt ply,
a ply rigidity of the belt ply which is a product (Ea×Na) of the tensile rigidity Ea and the end count Na is 14000˜20000 N/mm.

4. The pneumatic tire as set forth in claim 3, characterized in that, when Eb is a tensile rigidity of a band cord in an elongation range 3%˜5%, and Nb is a end count of band cords per 1 mm ply width in the perpendicular direction to the band cords in the band ply, a ply rigidity of the band ply which is a product (Eb×Nb) of the tension rigidity Eb and the end count Nb is 1600˜2500 N/mm.

5. The pneumatic tire as set forth in claim 1, characterized in that the tire outer diameter Dt (unit: mm) satisfies the following expressions (4), (5)
Dt=<59.078×Wt̂0.498 (4)
Dt>=59.078×Wt̂0.467 (5).

6. The pneumatic tire as set forth in claim 2, characterized in that, when Ea is a tensile rigidity of a belt cord in an elongation range 0.4%˜1.0%, and Na is a end count of belt cords per 1 mm ply width in the perpendicular direction to the belt cords in the first, second belt ply,
a ply rigidity of the belt ply which is a product (Ea×Na) of the tensile rigidity Ea and the end count Na is 14000˜20000 N/mm.

7. The pneumatic tire as set forth in claim 2, characterized in that the tire outer diameter Dt (unit: mm) satisfies the following expressions (4), (5)
Dt=<59.078×Wt̂0.498 (4)
Dt>=59.078×Wt̂0.467 (5).

8. The pneumatic tire as set forth in claim 3, characterized in that the tire outer diameter Dt (unit: mm) satisfies the following expressions (4), (5)
Dt=<59.078×Wt̂0.498 (4)
Dt>=59.078×Wt̂0.467 (5).

9. The pneumatic tire as set forth in claim 4, characterized in that the tire outer diameter Dt (unit: mm) satisfies the following expressions (4), (5)
Dt=<59.078×Wt̂0.498 (4)
Dt>=59.078×Wt̂0.467 (5).
